(19) United States
(12) Patent Application Publication
(10) Pub. No.: US 2026/0140997 A1
(43) Pub. Date: May 21, 2026

(54) METHOD AND SYSTEM IN A MULTI-DEVICE ENVIRONMENT FOR REMOTE FILE ACCESS

(71) Applicant: SAMSUNG ELECTRONICS CO., LTD., Suwon-si (KR)

(72) Inventors: Venugopal Sulur Muruganathan, Bangalore (IN); Sai Charan Kanigolla, Bangalore (IN); Sampath Arunachalam, Bangalore (IN); Jitender Sajwan, Bangalore (IN); Madhan Raj Kanagarathinam, Bangalore (IN); Minseok Kim, Suwon-si (KR); Chihyun Cho, Suwon-si (KR)

(73) Assignee: SAMSUNG ELECTRONICS CO., LTD., Suwon-si (KR)

(21) Appl. No.: 19/402,588

(22) Filed: Nov. 26, 2025

Related U.S. Application Data
(63) Continuation of application No. PCT/KR2025/018987, filed on Nov. 17, 2025.

(30) Foreign Application Priority Data
Nov. 19, 2024 (IN) 202441089716
Oct. 23, 2025 (IN) 202441089716

(51) Int. Cl. G06F 16/54; G06F 16/538; G06T 3/40

(52) U.S. Cl. CPC G06F 16/54; G06F 16/538; G06T 3/40; G06T 2200/24

(57) ABSTRACT

A method for remote file access, includes: establishing, by a host device, a communication session with one or more remote devices for accessing one or more files on the one or more remote devices; based on the communication session being established, transmitting, by the host device, a request for a thumbnail image associated with each file of the one or more files from the one or more remote devices; receiving, by the host device, the thumbnail image corresponding to each file of the one or more files from the one or more remote devices, wherein the thumbnail image is generated by the one or more remote devices based on the one or more files; and displaying, by the host device, the thumbnail image corresponding to each file of the one or more files on a user interface of the host device.

### CROSS-REFERENCE TO RELATED APPLICATIONS

This application is a continuation of PCT/KR2025/018987 filed on Nov. 17, 2025, which is based on and claims priority to Indian Patent Provisional Application No. 202441089716 filed on Nov. 19, 2024, and Indian Patent Non-Provisional Application No. 202441089716 filed on Oct. 23, 2025, in the Indian Patent Office, the disclosures of which are incorporated by reference herein in their entireties.

### BACKGROUND

### 1. Field

The present disclosure relates generally to accessing files, and more particularly, to a method and a system in a multi-device environment for enhanced remote file access.

### 2. Description of Related Art

In a multi-device environment, remote file access plays a crucial role in enabling users to seamlessly access and share digital content such as photos, videos, music, and documents across various devices, including smartphones, tablets, laptops, and smart TVs. This capability fosters a more connected and efficient workflow, allowing users to collaborate in real time, work from different locations, and maintain consistent access to important files without the need for manual transfers or duplications. As a result, remote file access significantly enhances both productivity and user convenience in personal, professional, and collaborative settings.

FIG. 1 illustrates an example representation of a related art environment 100 depicting communication between host devices and a remote device. The host devices include multiple devices such as smartphones 108, televisions 106, and computers 104 in multi-device environment. These devices are in communication with the remote device i.e., file share server 102 via a network 110. Herein, the remote device allows users to easily access and share of files, for example, photos, videos, music, and other documents to multiple devices, enhancing collaboration and productivity. Moreover, the shared files appear as though they are stored locally on each device, providing a smooth and integrated user experience. This functionality is made possible through common storage-sharing protocols such as Server Message Block (SMB), Common Internet File System (CIFS), Network File System (NFS).

Further, to improve user experience, the file browser application generates thumbnails for shared files to provide a visual representation of the contents of the file. Thumbnail handling for local files is typically performed directly on the device where the file resides. Operating systems use built-in thumbnail generation tools to create visual previews of files. These thumbnails are often cached to improve performance and reduce the need for repeated processing. In the present disclosure, a ‘file’ may refer to, or include, a content including at least one piece of visual information. For example, a file may include an image, a video, or a document. The file may include data for generating a thumbnail corresponding to the content included in the file. The term ‘file’ may be used interchangeably with terms such as ‘information,’ ‘content,’ or ‘data.’ A ‘thumbnail’ may refer to visual information representing the content included in the file. For example, a thumbnail may include information that allows approximate identification of the content included in the file without opening the file itself. The term ‘thumbnail’ may be used interchangeably with terms such as ‘content representing the file’ or ‘content indicative of the file.’

However, there are certain limitations when accessing the files from the remote devices and with the generation of the thumbnails for the remotely shared files. The common sharing common storage-sharing protocols do not natively support the retrieval of thumbnails from remote devices. Moreover, the existing methods for sharing files via the remote device typically require downloading the entire file or a significant portion of it to generate a thumbnail, as shown in FIG. 2. This results in excessive consumption of network bandwidth, increased latency, and higher computational load. This leads to slower content load times and reduces overall performance. When accessing shared files from the remote device, the host device typically downloads the file, either fully or partially, on a temporary basis to generate a thumbnail locally. This process introduces significant delays, especially when dealing with large files, numerous items, or limited network bandwidth. In cases where thumbnails cannot be generated efficiently, the host device displays a default or generic thumbnail instead. The generic thumbnail offers little visual information, ultimately diminishing the overall user experience. Moreover, to generate the thumbnail, the remote device needs a network request for each file/folder to be downloaded. Furthermore, the slow or limited network speed and stability impact the accessibility of the files from the remote device.

Thus, based on the aforementioned paragraph, it is clear that the existing file-sharing protocols do not provide built-in support for thumbnail handling or previewing files that are shared remotely. As a result, users are unable to view visual previews of remote files, such as images or videos, directly from the host device. The absence of thumbnails or content previews significantly impacts the user experience, making it harder to identify files quickly and efficiently.

Accordingly, there exists a need for an improved method and a system for remote file access experience that addresses the limitations of the related art.

### SUMMARY

According to an aspect of the disclosure, a method for remote file access, includes: establishing, by a host device, a communication session with one or more remote devices for accessing one or more files on the one or more remote devices; based on the communication session being established, transmitting, by the host device, a request for a thumbnail image associated with each file of the one or more files from the one or more remote devices; receiving, by the host device, the thumbnail image corresponding to each file of the one or more files from the one or more remote devices, wherein the thumbnail image is generated by the one or more remote devices based on the one or more files; and displaying, by the host device, the thumbnail image corresponding to each file of the one or more files on a user interface of the host device.

According to an aspect of the disclosure, a method for remote file access, includes: establishing, by a remote device, a communication session with a host device for providing access to one or more files on the remote device; receiving, by the remote device, a request for a thumbnail image associated with each file of the one or more files from the host device; determining, by the remote device, for each file of the one or more files, whether a corresponding thumbnail image is pre-stored in a cache memory of the remote device; performing, by the remote device, for each file of the one or more files, one of: based on determining that the corresponding thumbnail image is pre-stored in the cache memory, fetching, the corresponding thumbnail image from the cache memory, or generating, the corresponding thumbnail image, based on the corresponding file; and transmitting, by the remote device, the thumbnail image corresponding to each file to the host device.

According to an aspect of the disclosure, an electronic device includes: a user interface; memory storing instructions; and at least one processor) operatively coupled with the memory, wherein the instructions, when executed by the at least one processor individually or collectively, cause the electronic device to: establish a communication session with one or more remote devices for accessing one or more files on the one or more remote devices; based on the communication session being established, transmit a request for a thumbnail image associated with each file of the one or more files from the one or more remote devices; receive the thumbnail image corresponding to each file of the one or more files from the one or more remote devices, wherein the thumbnail image is generated by the one or more remote devices based on the one or more files; and display the thumbnail image corresponding to each file of the one or more files on the user interface.

According to an aspect of the disclosure, an electronic device includes: memory storing instructions; and a cache memory; at least one processor operatively coupled with the memory and the cache memory, wherein the instructions, when executed by the at least one processor individually or collectively, cause the electronic device to: establish a communication session with a host device for providing access to one or more files on the electronic device; receiving a request for a thumbnail image associated with each file of the one or more files from the host device; determine for each file of the one or more files, whether a corresponding thumbnail image is pre-stored in the cache memory; perform for each file of the one or more files, one of: based on determining that the corresponding thumbnail image is pre-stored in the cache memory, fetching, the corresponding thumbnail image from the cache memory, or generating, the corresponding thumbnail image, based on the corresponding file; and transmit the thumbnail image corresponding to each file to the host device.

To further clarify the advantages and features of the present subject matter, a more particular description of the present disclosure will be rendered by reference to specific embodiments thereof, which are illustrated in the appended drawings. It is appreciated that these drawings depict only example embodiments of the present disclosure and are therefore not to be considered limiting of its scope. The present disclosure will be described and explained with additional specificity and detail in the accompanying drawings.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an example representation of a related art environment depicting communication between host devices and a remote device;

FIG. 2 illustrates an example representation showing generic thumbnails displayed on a host device in a related art technique;

FIG. 3 illustrates a communication between a client and a server based on a file sharing protocol, i.e., Server Message Block (SMB), as per related art art;

FIG. 4 illustrates an environment having a host device and one or more remote device, in accordance with an embodiment of the present disclosure;

FIG. 5 illustrates an example environment including systems for multi-device environment for remote file access, in accordance with an embodiment of the present disclosure;

FIG. 6 illustrates a process flow associated with an establishing module of the system on the host device, according to an embodiment of the present disclosure;

FIG. 7 illustrates a process flow associated with an establishing module of the system on the remote device, according to an embodiment of the present disclosure;

FIG. 8 illustrates a process flow associated with a performing module of the system, according to an embodiment of the present disclosure;

FIG. 9 illustrates an example implementation of the systems for remote file access in the multi-device environment, according to an embodiment of the present disclosure;

FIG. 10 illustrates an example working flow of the host device for remote file access in the multi-device environment, according to an embodiment of the present disclosure;

FIG. 11 illustrates an example implementation of a multi-connectivity handler at the host device for remote file access in the multi-device environment, according to an embodiment of the present disclosure;

FIG. 12 illustrates an example working flow of the remote device for remote file access in the multi-device environment, according to an embodiment of the present disclosure;

FIG. 13 illustrates an example working flow for generating a thumbnail image by a thumbnail generator at the remote device for remote file access in the multi-device environment, according to an embodiment of the present disclosure;

FIG. 14 illustrates an example working flow for generating metadata by a metadata handler at the remote device for remote file access in the multi-device environment, according to an embodiment of the present disclosure;

FIG. 15 illustrates a communication sequence between the host device and the remote device for remote file access in the multi-device environment, according to an embodiment of the present disclosure; and

FIGS. 16 and 17 illustrate flow charts depicting methods in a multi-device environment for remote file access, according to an embodiment of the present disclosure.

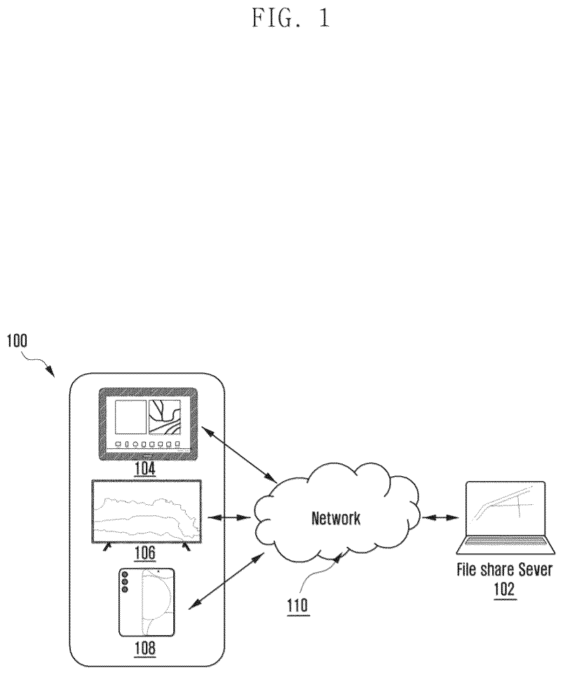

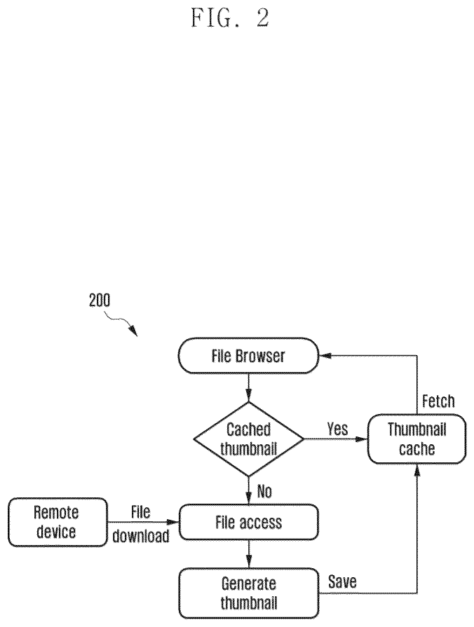

Further, skilled artisans will appreciate that elements in the drawings are illustrated for simplicity and may not have necessarily been drawn to scale. For example, the flow charts illustrate the in terms of the most prominent operations or steps involved to help to improve understanding of aspects of the present subject matter. Furthermore, in terms of the construction of the device, one or more components of the device may have been represented in the drawings by conventional symbols, and the drawings may show only those specific details that are pertinent to understanding the embodiments of the present subject matter so as not to obscure the drawings with details that will be readily apparent to those of ordinary skill in the art having the benefit of the description herein.

### DETAILED DESCRIPTION

For the purpose of promoting an understanding of the principles of the present disclosure, reference will now be made to the embodiment illustrated in the drawings and specific language will be used to describe the same. It will nevertheless be understood that no limitation of the scope of the present disclosure is thereby intended, such alterations and further modifications in the illustrated system, and such further applications of the principles of the present disclosure as illustrated therein being contemplated as would normally occur to one skilled in the art to which the present disclosure relates.

It will be understood by those skilled in the art that the foregoing general description and the following detailed description are explanatory of the present disclosure and are not intended to be restrictive thereof.

Reference throughout this specification to “an aspect”, “another aspect” or similar language means that a particular feature, structure, or characteristic described in connection with the embodiment is included in at least one embodiment of the present subject matter. Thus, appearances of the phrase “in an embodiment”, “in another embodiment” and similar language throughout this specification may, but do not necessarily, all refer to the same embodiment.

The terms “comprises”, “comprising”, “includes”, “including”, or any other variations thereof, are intended to cover a non-exclusive inclusion, such that a process or method that comprises a list of operations or steps does not include only those operations or steps but may include other operations or steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skilled in the art to which this present disclosure belongs. The system, methods, and examples provided herein are illustrative only and not intended to be limiting.

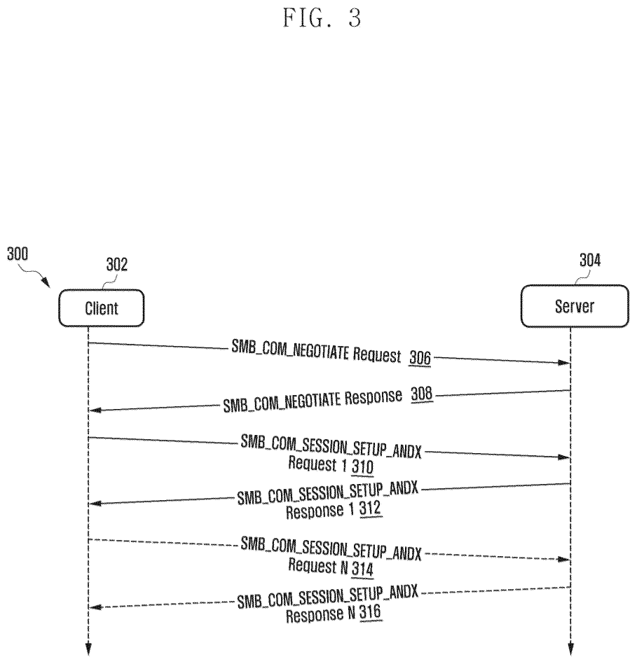

FIG. 3 illustrates a communication between a client 302 and a server 304 based on a file sharing protocol, i.e., Server Message Block (SMB), as per related art.

At 306, the client 302 transmits SMB_COM_NEGOTIATE Request message to the server 304.

At 308, the client 302 receives SMB_COM_NEGOTIATE Response message from the server 304.

At 310, the client 302 transmits SMB_COM_SESSION_SETUP_ANDX Request 1 message to the server 304.

At 312, the client 302 receives SMB_COM_SESSION_SETUP_ANDX Response 1 message from the server 304.

At 314, the client 302 transmits SMB_COM_SESSION_SETUP_ANDX Request N message to the server 304.

At 316, the client 302 receives SMB_COM_SESSION_SETUP_ANDX Response N message from the server 304.

Herein, the SMB protocol is widely used due to its ease of use, support for encryption and signing, and cross-platform compatibility. It enables remote access to files and directories, and list directory contents, read metadata such as file size, type, and timestamps, and open or read file data (for example, image bytes). Thumbnails, however, are not part of the SMB protocol itself, they are simply files or visual representations generated by the client using the retrieved file data.

Further, the present disclosure discloses a system and a method to extract one or more files from the server (remote device) optimally while displaying a thumbnail image corresponding to each file among one or more files received from the remote device.

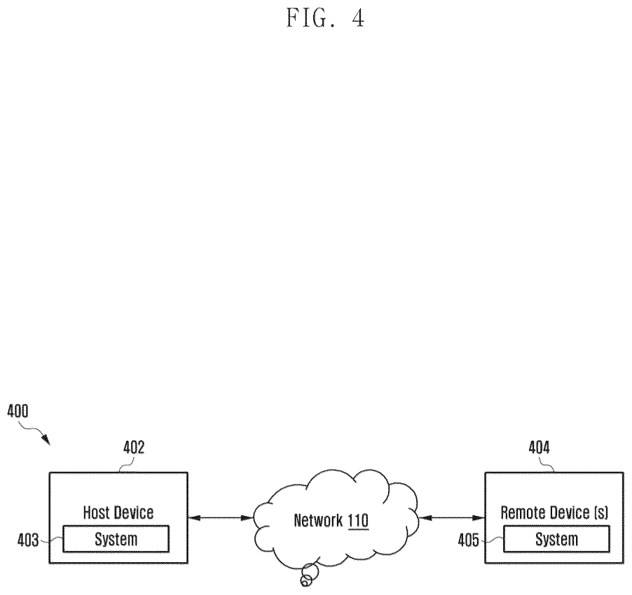

FIG. 4 illustrates an environment (alternatively referred to as multi-device environment 400) having host device 402, and one or more remote device (referred to herein as a remote device) 404, in accordance with an embodiment of the present disclosure.

In an embodiment, the host device 402 and the remote device 404 both play active roles, with either capable of storing and sharing files depending on the use case. The host device 402 typically initiates or manages the connection, while the remote device 404 holds the files to be accessed or transferred. A network, such as a local area network (LAN) or the internet, facilitates communication between the host device 402 and the remote device 404, enabling data to be securely transmitted across distances. Further, the host device 402 may include a system 403 and the remote device 404 may include a system 405. Herein, each of the system 403 and 405 may be configured to operate in such a manner that the host device 402 may display a thumbnail image corresponding to each file among the one or more files received from the remote device 404. The detailed operations performed by each system may be explained in the forthcoming paragraphs.

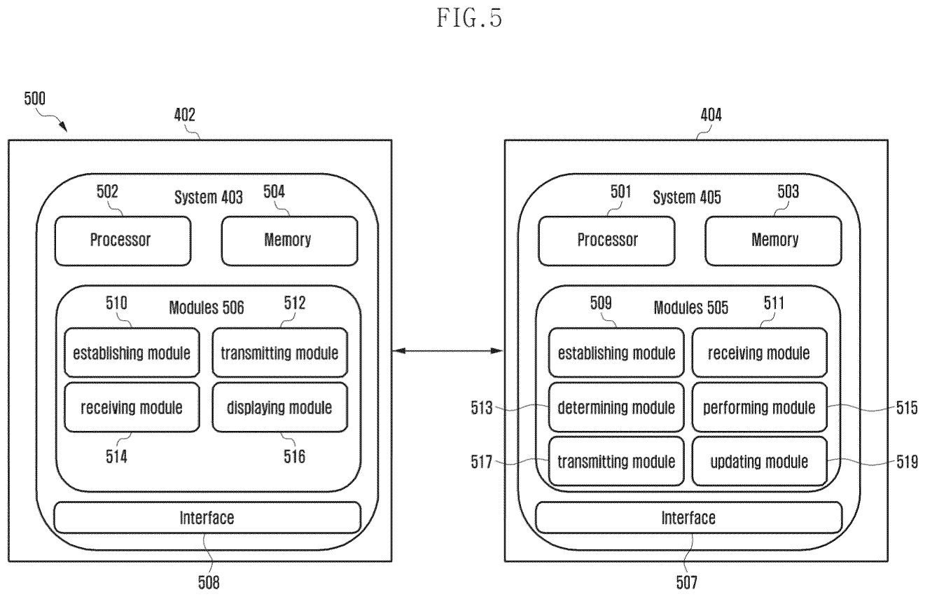

FIG. 5 illustrates an example environment 500 including systems 403 and 405 in the multi-device environment 400 for the remote file access, in accordance with an embodiment of the present disclosure. As shown, the environment 500 may include the system 403 implemented in the host device 402. The system 403 is connected to the system 405 corresponding to the remote device 404.

The system 403 may include one or more processors 502 (hereinafter referred to as the processor 502), memory 504, one or more modules 506 (referred to herein as the modules), and an interface 508. In an example embodiment, the one or more processors 502 may be in operatively coupled with the memory 504, the modules 506, and the interface 508.

In one embodiment, the processor 502 may include at least one data processor for executing processes in Virtual Storage Area Network. The processor 502 may include specialized processing units such as integrated system (bus) controllers, memory management control units, floating point units, graphics processing units, digital signal processing units, etc. In one embodiment, the processor 502 may include a Central Processing Unit (CPU), a Graphics Processing Unit (GPU), or both. The processor 502 may be one or more general processors, Digital Signal Processors (DSPs), application-specific integrated circuits, Field-Programmable Gate Arrays (FPGAs), servers, networks, digital circuits, analog circuits, combinations thereof, or other now known or later developed devices for analyzing and processing data. The processor 502 may execute a software program, such as code generated manually (i.e., programmed) to perform the desired operation. The processor 502 may implement various techniques such as, but not limited to, image processing, data extraction, Artificial Intelligence (AI), Machine Learning (ML), Deep Learning (DL), and so forth to achieve the desired objective.

In one embodiment, the processor 502 may be configured to perform the functions of the system 403 and/or the host device 402.

The processor 502 may be communicate with one or more Input/Output (I/O) devices, such as the system 405, via the interface 508. The interface 508 may employ communication Code-Division Multiple Access (CDMA), High-Speed Packet Access (HSPA+), Global System for Mobile Communications (GSM), Long-Term Evolution (LTE), WiMax, or the like, etc.

In an embodiment, the processor 502 may communicate with a communication network via a network interface. In an embodiment, the network interface may be the interface 508. The network interface may connect to the communication network to enable connection of the system 403 with the outside environment and/or device/system. The network interface may employ connection protocols including, without limitation, direct connect, Ethernet (e.g., twisted pair 10/100/1000 Base T), Transmission Control Protocol/Internet Protocol (TCP/IP), token ring, IEEE 802.11/b/g/n/x, etc. The communication network may include, without limitation, a direct interconnection, Local Area Network (LAN), Wide Area Network (WAN), wireless network (e.g., using Wireless Application Protocol (WAP)), the Internet, etc. Using the network interface and the communication network, the system 403 may communicate with other devices. The network interface may employ connection protocols including, but not limited to, direct connect, Ethernet (e.g., twisted pair 10/100/1000 Base T), TCP/IP, token ring, IEEE 802.11/b/g/n/x, etc.

The memory 504 may be communicatively coupled to the processor 502. The memory 504 may be configured to store data and instructions executable by the processor 502. In one embodiment, the memory 504 may communicate via a bus within the system 403. The memory 504 may include, but is not limited to, one or more of a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory 504 may include a cache or random-access memory for the processor 502. In alternative examples, the memory 504 is separate from the processor 502, such as a cache memory of a processor, the system memory, or other memory. The memory 504 may be an external storage device or database for storing data. The memory 504 may be operable to store instructions executable by the processor 502. The functions, acts, or tasks illustrated in the figures or described may be performed by the programmed processor 502 for executing the instructions stored in the memory 504. The functions, acts, or tasks are independent of the particular type of instruction set, storage media, processor, or processing strategy and may be performed by software, hardware, integrated circuits, firmware, micro-code, and the like, operating alone or in combination. Likewise, processing strategies may include multiprocessing, multitasking, parallel processing, and the like. The memory 504 may further include a database to store the data. Further, the memory 504 may include an operating system for performing one or more tasks of the system 403, as performed by a generic operating system in the communications domain.

For the sake of brevity, the architecture, and standard operations of the processor 502 and the memory 504 are not discussed in detail. In one embodiment, the memory 504 may be configured to store the information as required by the processor 502 to perform the techniques described herein.

The modules 506, amongst other things, include routines, programs, objects, components, data structures, etc., which perform particular tasks or implement data types. The modules 506 may also be implemented as, signal processor(s), state machine(s), logic circuitries, and/or any other device or component that manipulates signals based on operational instructions. The modules 506 may be configured to one or more operations of the system 403 and/or the processor 502.

Further, the modules 506 can be implemented in hardware, instructions executed by a processing unit, or by a combination thereof. The processing unit can comprise a computer, the processor 502, a state machine, a logic array, or any other suitable devices capable of processing instructions. The processing unit can be a general-purpose processor which executes instructions to cause the general-purpose processor to perform the required tasks, or the processing unit can be dedicated to performing the required functions. In another embodiment of the present disclosure, the modules 506 may be machine-readable instructions (software) that, when executed by a processor/processing unit, perform any of the described functionalities. Furthermore, the data serves, amongst other things, as a repository for storing data processed, received, and generated by one or more of the modules. The modules 506 may include an establishing module 510, a transmitting module 512, a receiving module 514, and a displaying module 516.

Additionally, the system 405 may be implemented within the remote device 404. The system 405 may include a processor 501, a memory 503, one or more modules 505 (referred to herein as the modules), and an interface 507. The processor 501 may be in operatively coupled with the memory 503, modules 505, and the interface 507. The constructional and operational features of the processor 501, a memory 503, modules 505, and the interface 507 may be the same as the processor 502, a memory 504, modules 506, and the interface 508. Thus, the same has not been explained for the sake of brevity. Herein, the modules 506 may include an establishing module 509, a receiving module 511, a determining module 513, a performing module 515, a transmitting module 517, and an updating module 519.

In an embodiment, the establishing module 510 may be configured to establish a communication session with the one or more remote devices for accessing one or more files on the one or more remote devices 404. The communication session may enable the host device 402 to communicate with the one or more remote devices over a network. The communication session may facilitate the transfer of data between the host device 402 and the one or more remote devices 404. The establishing module 510 may establish the communication session using one or more network protocols.

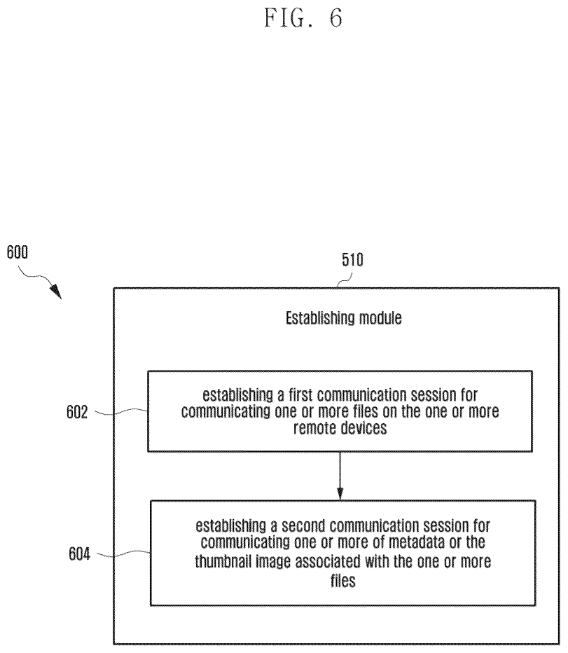

The establishing module 510 may now be described further in reference to FIG. 6.

FIG. 6 illustrates a process flow 600 associated with the establishing module 510 of the system 403, according to an embodiment of the present disclosure.

In an embodiment, the process flow 600 at 602 includes establishing a first communication session for communicating the one or more files on the one or more remote devices. The first communication session may be used, by the establishing module 510, to receive the one or more files from the one or more remote devices. The first communication session may be based on one of a SMB protocol, a CIFS protocol, or a NFS protocol. The first communication session may enable the host device 402 to access the one or more files stored on the one or more remote devices 404. The first communication session may allow the host device 402 to perform operations including reading file data, listing directory contents, and accessing file attributes.

In an embodiment, the process flow 600 at 604 includes establishing a second communication session for communicating one or more of the metadata or the thumbnail image associated with the one or more files. The second communication session may be used, by the establishing module 510, to receive one or more of the metadata or the thumbnail image associated with the one or more files from the one or more remote devices. The second communication session may be based on TCP. The second communication session may be separate from the first communication session. The second communication session may enable transfer of the metadata or the thumbnail image. The metadata may include information describing properties of the one or more files. The metadata may include file size, file type, creation date, modification date, and file name. The thumbnail image may include a visual representation of a file among the one or more files.

Referring again to FIG. 5, in an embodiment, the establishing module 509 may be configured to establish the communication session with the host device 402 for providing access to the one or more files on the remote device 404. The establishing module 509 may operate on the remote device 404 side to complement the establishing module 510 on the host device 402 side. The establishing module 509 may enable the remote device 404 to accept and respond to connection requests from the host device 402.

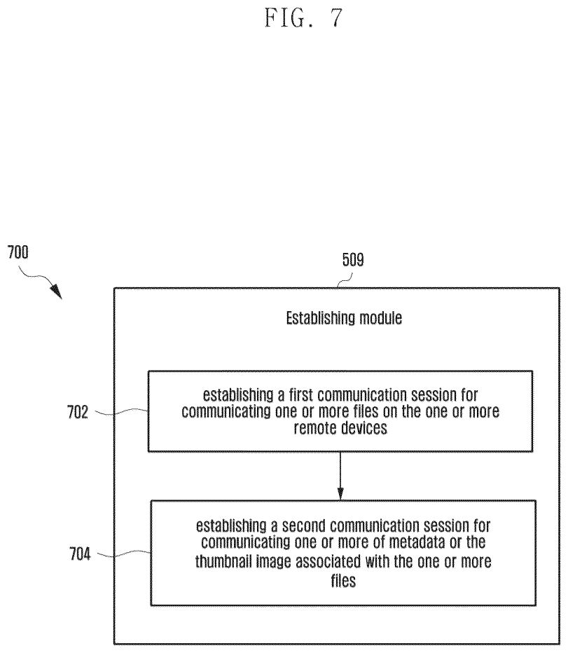

The establishing module 509 may now be described further in reference to FIG. 7.

FIG. 7 illustrates a process flow 700 associated with the establishing module 509 of the system 405, according to an embodiment of the present disclosure.

In an embodiment, the process flow 700 at 702 includes establishing the first communication session for communicating the one or more files on the one or more remote devices 404. The first communication session may be used, by the establishing module 509, to transmit the one or more files to the host device 402. The establishing module 509 may establish the first communication session in response to a connection request from the host device 402. The first communication session established by the establishing module 509 may correspond to the first communication session established by the establishing module 510. The first communication session may be based on one of the SMB protocols, the CIFS protocol, or the NFS protocol.

In an embodiment, the process flow 700 at 704 includes establishing the second communication session for communicating the one or more of metadata or the thumbnail image associated with the one or more files. The second communication session may be used, by the establishing module 509, to transmit the one or more of metadata or the thumbnail image associated with the one or more files to the host device 402. The establishing module 509 may establish the second communication session in response to a connection request from the host device 402. The second communication session established by the establishing module 509 may correspond to the second communication session established by the establishing module 510. The second communication session may be based on the TCP.

Accordingly, the establishing module 510 and the establishing module 509 may work cooperatively to establish both the first communication session and the second communication session between the host device 402 and the remote device 404. The first communication session may handle file access operations while the second communication session may handle the metadata and the thumbnail image transfer. The dual communication session approach may enable efficient remote file access by separating file transfer operations from metadata and thumbnail image transfer operations.

Referring again to FIG. 5, in an embodiment, the transmitting module 512 may be configured to transmit a request for a thumbnail image associated with each file among the one or more files from the one or more remote devices in response to establishing the communication session. The transmitting module 512 may transmit the request for the thumbnail image over the second communication session. The request for the thumbnail image may be transmitted to initiate the generation or retrieval of the thumbnail image from the one or more remote devices. The request for the thumbnail image includes one or more parameters defining conditions that the generated thumbnail image is required to satisfy. The one or more parameters may include, for example, one or more of a configuration of the user interface, a file path, a height of the thumbnail image, a width of the thumbnail image, an orientation of the thumbnail image, and an output format of the thumbnail image. The transmitting module 512 may transmit these parameters so that the remote device 404 generates the thumbnail image in accordance with the specified requirements (e.g., target dimensions, rotation, or format). The configuration of the user interface may specify layout parameters for displaying the thumbnail image on the user interface of the host device 402. The file path may specify a location of a file among the one or more files on the remote device 404. The height of the thumbnail image and the width of the thumbnail image may specify dimensions for the thumbnail image. The orientation of the thumbnail image may specify a rotation angle for the thumbnail image. The output format of the thumbnail image may specify an image file format such as JPEG, PNG, or BMP.

In an embodiment, the receiving module 511 may be configured to receive the request for the thumbnail image associated with each file among the one or more files from the host device 402. The receiving module 511 may receive the request for the thumbnail image over the second communication session. The receiving module 511 may extract the one or more parameters from the request for the thumbnail image. The one or more parameters may be used by the remote device 404 to generate or retrieve the corresponding thumbnail image. The extracted parameters may define conditions that the thumbnail image to be generated is required to satisfy, such as the target size, orientation, output type, or other visual constraints. The remote device 404 may generate or retrieve the corresponding thumbnail image in accordance with the extracted parameters, ensuring that the thumbnail image conforms to the requirements specified in the request.

In an embodiment, the determining module 513 may be configured to determine for each file among the one or more files, whether a corresponding thumbnail image is pre-stored in a cache memory of the remote device 404. The determining module 513 may check the cache memory to identify whether the corresponding thumbnail image already exists. The cache memory may store previously generated thumbnail images to improve performance. The determining module 513 may compare parameters of the request for the thumbnail image with parameters of thumbnail images stored in the cache memory. The determining module 513 may determine that the corresponding thumbnail image is pre-stored when a thumbnail image matching the requested parameters exists in the cache memory.

In an embodiment, the performing module 515 may be configured to perform for each file among the one or more files, one of: fetching the corresponding thumbnail image from the cache memory in response to the determination that the corresponding thumbnail image is pre-stored in the cache memory, or generating the corresponding thumbnail image based on the corresponding file. The performing module 515 may fetch the corresponding thumbnail image from the cache memory when the determining module 513 determines that the corresponding thumbnail image is pre-stored. The performing module 515 may generate the corresponding thumbnail image when the determining module 513 determines that the corresponding thumbnail image is not pre-stored in the cache memory.

In some embodiments, the thumbnail image may be generated and transmitted prior to completion of the file transmission and/or during transmission of the file over the first communication session. Accordingly, the host device may display the thumbnail image without waiting for the corresponding file to be fully received.

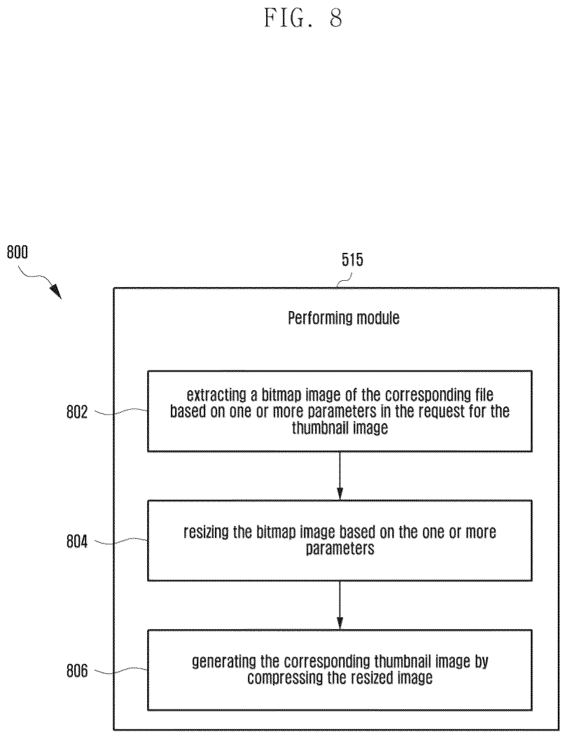

The performing module 515 may be further described in reference to FIG. 8.

FIG. 8 illustrates a process flow 800 associated with the performing module 515 of the system 405, according to an embodiment of the present disclosure.

In an embodiment, the process flow 800 at 802 includes extracting a bitmap image of the corresponding file based on one or more parameters in the request for the thumbnail image. The one or more parameters comprise one or more of the configuration of the user interface, the file path, the height of the thumbnail image, the width of the thumbnail image, the orientation of the thumbnail image, and the output format of the thumbnail image. The performing module 515 may read the corresponding file from storage of the remote device 404. The performing module 515 may decode the corresponding file to obtain the bitmap image. The bitmap image may represent pixel data of the corresponding file.

In an embodiment, the process flow 800 at 804 includes resizing the bitmap image based on the one or more parameters. The performing module 515 may resize the bitmap image to match the height of the thumbnail image and width of the thumbnail image specified in the one or more parameters. The performing module 515 may apply the orientation of the thumbnail image to rotate the bitmap image as specified in the one or more parameters. The resizing may reduce the dimensions of the bitmap image to create a smaller representation suitable for display on the user interface of the host device 402.

In an embodiment, the process flow 800 at 806 includes generating the corresponding thumbnail image by compressing the resized image. The performing module 515 may apply compression techniques to reduce file size of the resized image. The performing module 515 may convert the resized image to the output format of the thumbnail image as specified in the one or more parameters. The compression may reduce bandwidth requirements for transmitting the corresponding thumbnail image to the host device 402.

Referring again to FIG. 5, in an embodiment, the updating module 519 may be configured to update the corresponding thumbnail image in the cache memory. The updating module 519 may store the corresponding thumbnail image in the cache memory in response to generating the corresponding thumbnail image. The updating module 519 may associate the corresponding thumbnail image with the one or more parameters used to generate the corresponding thumbnail image. The updating module 519 may enable faster retrieval of the corresponding thumbnail image for future requests with matching parameters.

In an embodiment, the transmitting module 517 may be configured to transmit the thumbnail image corresponding to each file to the host device 402 to enhance remote file access. The transmitting module 517 may transmit the thumbnail image corresponding to each file over the second communication session. The transmitting module 517 may transmit the thumbnail image corresponding to each file that was fetched from the cache memory or generated by the performing module 515.

In an embodiment, the receiving module 514 may be configured to receive the thumbnail image corresponding to each file among the one or more files from the one or more remote devices. The thumbnail image is generated by the one or more remote devices based on the one or more files. The receiving module 514 may receive the thumbnail image corresponding to each file over the second communication session. The receiving module 514 may store the thumbnail image corresponding to each file in the memory 504 of the host device 402.

In an embodiment, the displaying module 516 may be configured to display the thumbnail image corresponding to each file among the one or more files on a user interface of the host device 402 to enhance remote file access. The displaying module 516 may render the thumbnail image corresponding to each file on a display screen of the host device 402. The displaying module 516 may arrange the thumbnail image corresponding to each file according to the configuration of the user interface. The thumbnail image corresponding to each file may provide a visual preview of content of each file among the one or more files. The thumbnail image corresponding to each file may enable a user to quickly identify and select desired files without downloading complete file data.

In addition to the thumbnail image, the system 403 and the system 405 may be configured to communicate metadata associated with the one or more files. The metadata may provide additional information about the one or more files to further enhance remote file access. The metadata may be communicated over the second communication session.

In an embodiment, the transmitting module 512 may be configured to transmit a request for metadata associated with each file among the one or more files from the one or more remote devices. The transmitting module 512 may transmit the request for metadata over the second communication session. The request for metadata may be transmitted in response to establishing the communication session or in response to user input requesting file information.

In an embodiment, the receiving module 511 may be configured to receive the request for metadata associated with each file among the one or more files from the host device 402 in response to establishing the communication session. The receiving module 511 may receive the request for metadata over the second communication session. The receiving module 511 may parse the request for metadata to identify which files require metadata transmission.

In an embodiment, the transmitting module 517 may be configured to transmit the metadata corresponding to each file to the host device 402. The metadata may be obtained based on parsing a file header of the corresponding file. The transmitting module 517 may extract the metadata from the file header without requiring download of complete file content. The metadata may include file size, file type, creation date, modification date, and file name. The transmitting module 517 may transmit the metadata over the second communication session.

In an embodiment, the receiving module 514 may be configured to receive the metadata corresponding to each file among the one or more files from the one or more remote devices. The receiving module 514 may receive the metadata over the second communication session.

In an embodiment, the displaying module 516 may be configured to display the metadata corresponding to each file among the one or more files on the user interface of the host device 402 to enhance remote file access. The displaying module 516 may display the metadata alongside the thumbnail image corresponding to each file. The displaying module 516 may present the metadata in a readable format on the user interface. The metadata may provide a user with detailed information about each file among the one or more files without requiring the download of the complete file.

Accordingly, the system 403 and the system 405 may work cooperatively to enable efficient remote file access in the multi-device environment 400. The host device 402 may transmit requests for the thumbnail image and the metadata over the second communication session. The remote device 404 may determine whether the corresponding thumbnail image is pre-stored in the cache memory and may either fetch the corresponding thumbnail image from the cache memory or generate the corresponding thumbnail image based on the corresponding file. The remote device 404 may transmit the thumbnail image corresponding to each file and the metadata corresponding to each file to the host device 402. The host device 402 may display the thumbnail image corresponding to each file and the metadata corresponding to each file on the user interface to enhance remote file access. The dual communication session approach may separate file transfer operations from metadata and thumbnail image transfer operations to improve performance and reduce network bandwidth consumption.

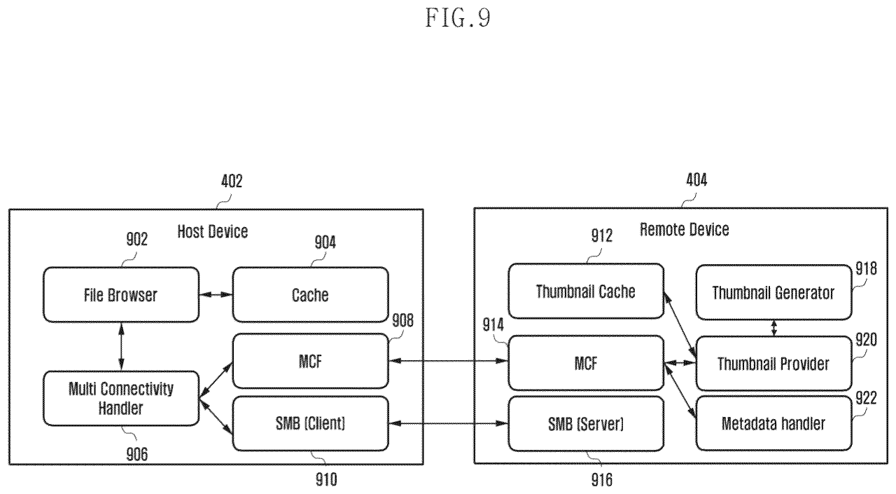

FIG. 9 illustrates an example implementation of the system 403 and the system 405 for remote file access in the multi-device environment 400, according to an embodiment of the present disclosure.

In an embodiment, the host device 402 may include a file browser 902, a cache 904, a Multi Connectivity Handler 906, a Multi Connectivity Framework (MCF) 908, and a SMB (Client) 910. The file browser 902 may provide a user interface for viewing media content on the host device 402. The file browser 902 may allow the user to navigate through directories and access the one or more files. The cache 904 may store metadata and thumbnail images retrieved from the one or more remote devices. The cache 904 may enable faster access to previously retrieved information. The multi-connectivity handler 906 may be implemented for hardware resource sharing. The multi-connectivity handler 906 may communicate with the MCF 908 for session establishment. The multi-connectivity handler 906 may handle messages to provide the metadata and the thumbnail images. The multi-connectivity handler 906 may forward file access calls to the SMB (Client) 910. The MCF 908 may be responsible for discovery and session establishment to the one or more remote devices. The MCF 908 may establish the second communication session for communicating the metadata and the thumbnail image. The SMB (Client) 910 may provide SMB protocol implementation. The SMB (Client) 910 may establish the first communication session with the remote device 404.

In an embodiment, the remote device 404 may include a thumbnail cache 912, an MCF 914, a SMB (Server) 916, a thumbnail generator 918, a thumbnail provider 920, and a metadata handler 922. The thumbnail cache 912 may store indexed media collections to access media files. The thumbnail cache 912 may enable faster retrieval of previously generated thumbnail images. The MCF 914 may be responsible for discovery and session establishment to devices in proximity. The MCF 914 may establish the second communication session with the host device 402. The SMB (Server) 916 may provide SMB protocol implementation. The SMB (Server) 916 may establish the first communication session with the host device 402. The thumbnail generator 918 may generate thumbnail images for requested media files. The thumbnail generator 918 may use device libraries for generating the thumbnail image for a file among the one or more files. The thumbnail provider 920 may handle thumbnail related communication. The thumbnail provider 920 may check whether a corresponding thumbnail image exists in the thumbnail cache 912. The metadata handler 922 may fetch metadata for requested media files. The metadata handler 922 may use device libraries for extracting required metadata for a requested file path.

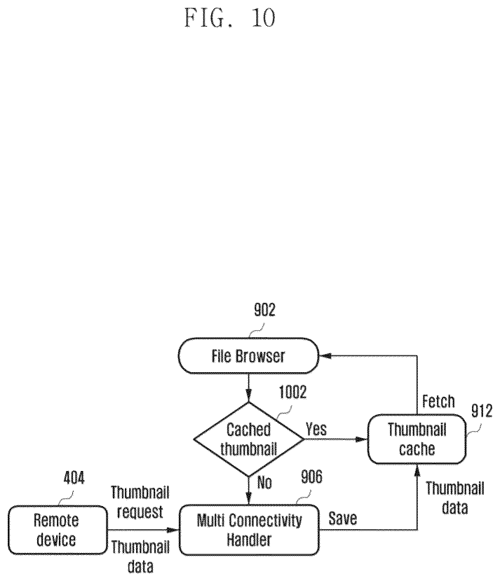

FIG. 10 illustrates an example working flow of the host device 402 for remote file access in the multi-device environment 400, according to an embodiment of the present disclosure.

The file browser 902 may request content from a shared folder. The file browser 902 may determine at 1002 whether a cached thumbnail exists in the cache 904. Operation 1002 may involve checking whether the corresponding thumbnail image has been previously retrieved and stored in the cache 904. When the corresponding thumbnail image is cached, the file browser 902 may fetch the corresponding thumbnail image from the thumbnail cache 912. When the corresponding thumbnail image is not cached, the file browser 902 may send a thumbnail request to the multi-connectivity handler 906. The multi-connectivity handler 906 may communicate with the remote device 404 to obtain the corresponding thumbnail image. The multi-connectivity handler 906 may receive thumbnail data from the remote device 404. The multi-connectivity handler 906 may save the thumbnail data to the thumbnail cache 912 for future retrieval. The saved thumbnail data may be provided to the file browser 902 for display.

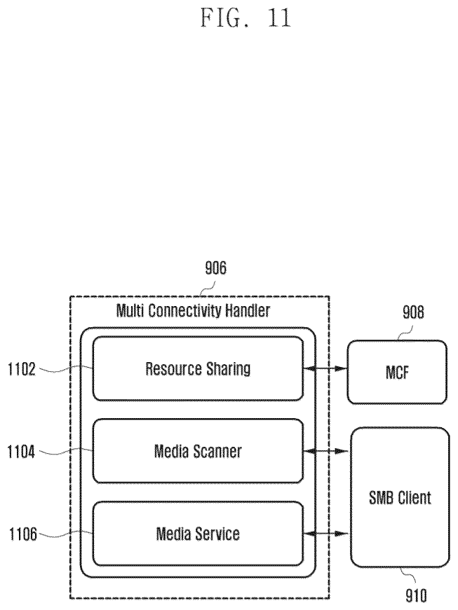

FIG. 11 illustrates an example implementation of the multi-connectivity handler 906 at the host device 402 for remote file access in the multi-device environment 400, according to an embodiment of the present disclosure.

The multi-connectivity handler 906 may include a resource sharing component 1102, a media scanner component 1104, and a media service component 1106. The resource sharing component 1102 may exchange data with the remote device 404 on a secondary channel. The resource sharing component 1102 may interact with the MCF 908 to obtain thumbnail data from the remote device 404. The resource sharing component 1102 may handle communication for the metadata and the thumbnail image over the second communication session. The media scanner component 1104 may list contents of a remotely shared directory. The media scanner component 1104 may use the SMB (Client) 910 via platform Application Programming Interface (API) to fetch a list of contents present in a shared folder. The media scanner component 1104 may enumerate the one or more files available on the remote device 404. The media service component 1106 may handle directory and file operations. The media service component 1106 may use the SMB (Client) 910 via the platform API to fetch file data. The media service component 1106 may process file access requests from the file browser 902.

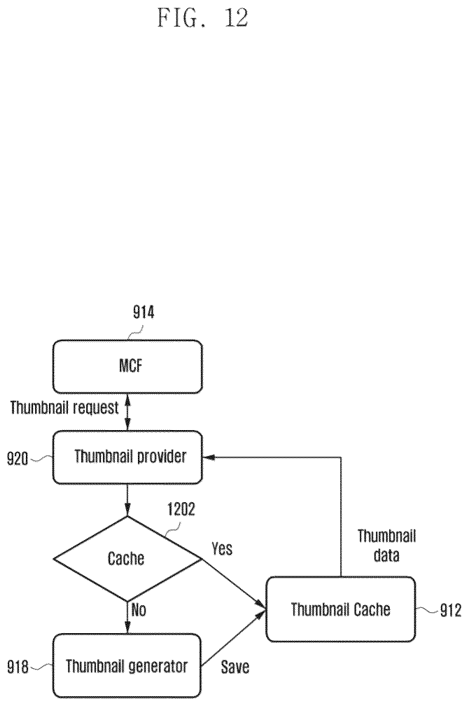

FIG. 12 illustrates an example working flow of the remote device 404 for remote file access in the multi-device environment 400, according to an embodiment of the present disclosure.

The MCF 914 may receive a thumbnail request from the host device 402. The MCF 914 may forward the thumbnail request to the thumbnail provider 920. The thumbnail provider 920 may check at 1202 whether the corresponding thumbnail image exists in the thumbnail cache 912. Operation 1202 may involve determining whether the corresponding thumbnail image has been previously generated and stored. When the corresponding thumbnail image exists in the thumbnail cache 912, the thumbnail provider 920 may retrieve the corresponding thumbnail image from the thumbnail cache 912. The thumbnail provider 920 may provide the thumbnail data directly from the thumbnail cache 912. When the corresponding thumbnail image does not exist in the thumbnail cache 912, the thumbnail provider 920 may invoke the thumbnail generator 918. The thumbnail generator 918 may generate the corresponding thumbnail image based on the corresponding file. The thumbnail generator 918 may save the generated thumbnail data to the thumbnail cache 912 for future requests. The thumbnail provider 920 may provide the thumbnail data to the MCF 914. The MCF 914 may transmit the thumbnail data to the host device 402.

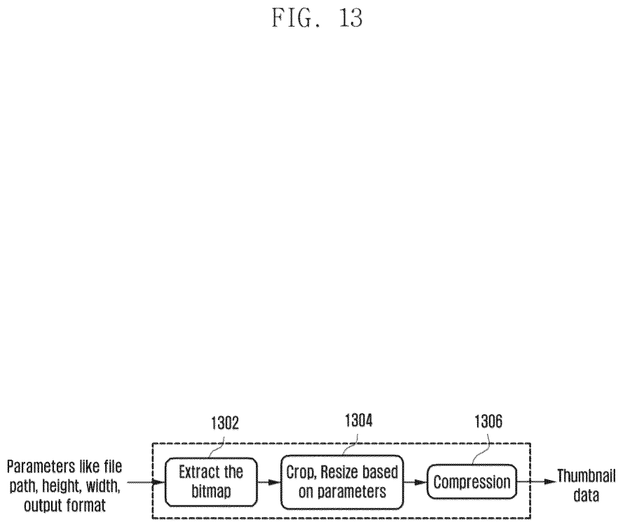

FIG. 13 illustrates an example working flow for generating a thumbnail image by the thumbnail generator 918 at the remote device 404 for remote file access in the multi-device environment 400, according to an embodiment of the present disclosure.

The thumbnail generator 918 may receive parameters including the file path, the height of the thumbnail image, the width of the thumbnail image, and the output format of the thumbnail image. The parameters may specify requirements for generating the corresponding thumbnail image. At 1302, the thumbnail generator 918 may extract a bitmap image of the corresponding file. The thumbnail generator 918 may read the corresponding file using the file path. For a video file, a frame at a particular time may be selected for extracting the bitmap image. For an image file, the thumbnail generator 918 may decode the image data to obtain the bitmap image. At 1304, the thumbnail generator 918 may crop and resize the bitmap image based on the one or more parameters. The thumbnail generator 918 may adjust dimensions of the bitmap image to match the height of the thumbnail image and the width of the thumbnail image. At 1306, the thumbnail generator 918 may perform compression on the resized bitmap image. The compression may reduce the file size of the thumbnail data. The thumbnail generator 918 may convert the compressed image to the output format of the thumbnail image. The thumbnail generator 918 may output the thumbnail data for transmission to the host device 402.

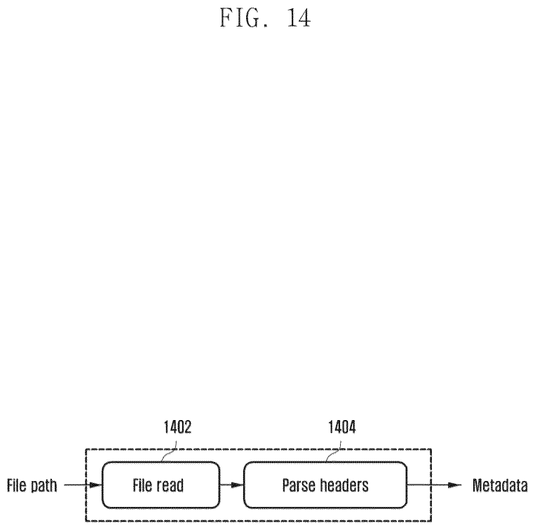

FIG. 14 illustrates an example working flow for generating metadata by the metadata handler 922 at the remote device 404 for remote file access in the multi-device environment 400, according to an embodiment of the present disclosure.

The metadata handler 922 may receive a file path identifying a file among the one or more files. At 1402, the metadata handler 922 may perform a file read operation to access the corresponding file. The metadata handler 922 may open the corresponding file using the file path. At 1404, the metadata handler 922 may parse headers of the corresponding file. The metadata handler 922 may extract metadata from a file header of the corresponding file. The metadata handler 922 may use device-provided libraries for parsing the file header. The metadata may include file size, file type, creation date, modification date, and file name. The metadata handler 922 may output the metadata for transmission to the host device 402.

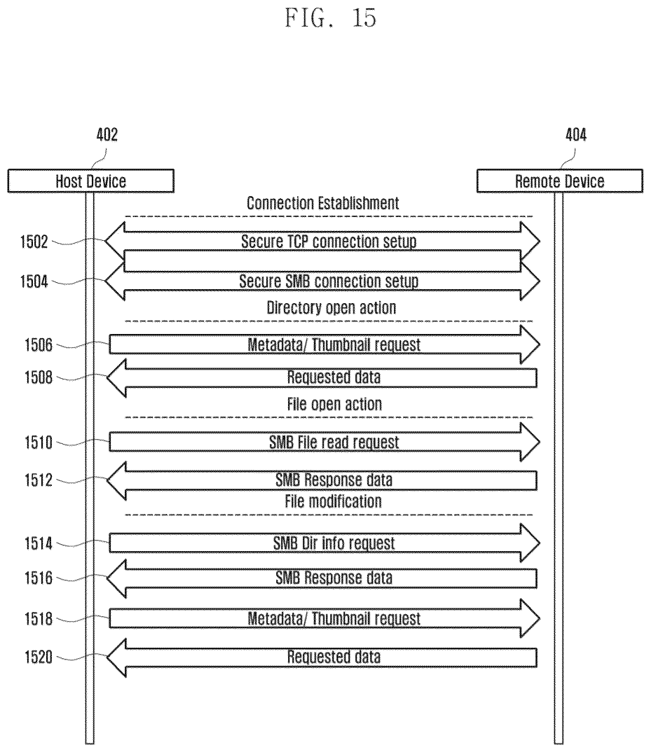

FIG. 15 illustrates a communication sequence between the host device 402 and the remote device 404 for remote file access in the multi-device environment 400, according to an embodiment of the present disclosure.

The host device 402 and the remote device 404 may initiate a connection establishment process. The connection establishment process may enable communication between the host device 402 and the remote device 404.

At 1502, the host device 402 and the remote device 404 may establish a secure TCP connection setup. The secure TCP connection setup may establish the second communication session based on TCP. The second communication session may be used for communicating the metadata and the thumbnail image. Because the first and second communication sessions operate independently of each other, the thumbnail image and metadata may be transmitted in parallel with the file transmission. As a result, the host device may obtain and display the thumbnail image and information related to the metadata without waiting for the file transmission to complete.

At 1504, the host device 402 and the remote device 404 may establish a secure SMB connection setup. The secure SMB connection setup may establish the first communication session based on the SMB protocol. The first communication session may be used for communicating the one or more files.

The host device 402 may perform a directory open action. The directory open action may allow the host device 402 to access a directory on the remote device 404 containing the one or more files.

At 1506, the host device 402 may transmit a metadata/thumbnail request to the remote device 404. The metadata/thumbnail request may include the request for the thumbnail image and the request for metadata associated with each file among the one or more files. The metadata/thumbnail request may be transmitted over the second communication session.

At 1508, the host device 402 may receive requested data from the remote device 404. The requested data may include the thumbnail image corresponding to each file and the metadata corresponding to each file. The requested data may be received over the second communication session.

The host device 402 may perform a file open action. The file open action may initiate access to a specific file among the one or more files on the remote device 404.

At 1510, the host device 402 may transmit a SMB file read request to the remote device 404. The SMB file read request may request file data from the remote device 404. The SMB file read request may be transmitted over the first communication session.

At 1512, the host device 402 may receive SMB response data from the remote device 404. The SMB response data may include the file data requested by the host device 402. The SMB response data may be received over the first communication session.

At 1514, the host device 402 may transmit a SMB dir info request to the remote device 404. The SMB dir info request may request updated directory information from the remote device 404. The SMB dir info request may be transmitted over the first communication session.

At 1516, the host device 402 may receive SMB response data from the remote device 404. The SMB response data may include updated directory information. The SMB response data may be received over the first communication session.

The host device 402 may detect a file modification. The file modification may trigger a need to update information about the one or more files on the remote device 404.

At 1518, the host device 402 may transmit a metadata/thumbnail request to the remote device 404. The metadata/thumbnail request may request updated thumbnail images and updated metadata for modified files. The metadata/thumbnail request may be transmitted over the second communication session.

At 1520, the host device 402 may receive requested data from the remote device 404. The requested data may include updated thumbnail images and updated metadata. The requested data may be received over the second communication session.

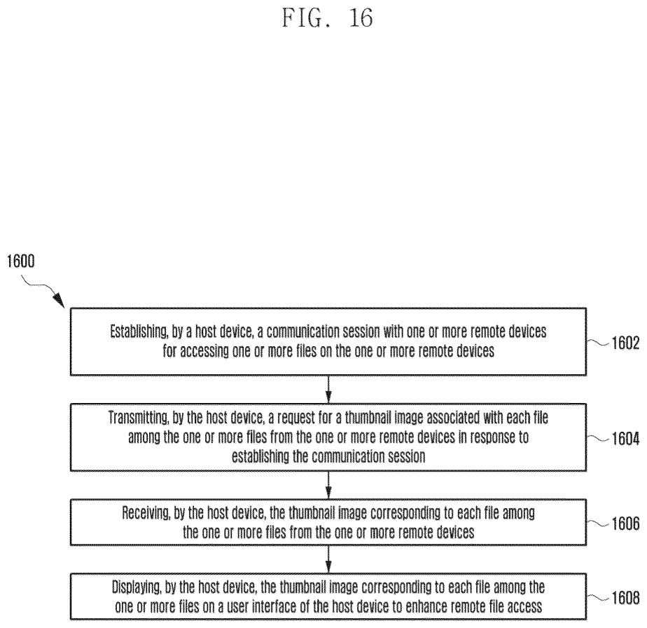

The method 1600 includes a series of operations shown at 1602 through 1608 of FIG. 16. The method 1600 may be performed by the system 403 in conjunction with modules 506, the details of which are explained in conjunction with FIGS. 5 to 15, and the same are not repeated here for the sake of brevity in the present disclosure. The method 1600 begins at 1602.

At 1602, the method 1600 includes establishing, by the host device 402, the communication session with one or more remote devices 404 for accessing the one or more files on the one or more remote devices 404.

The method 1600 includes establishing the first communication session for communicating the one or more files on the one or more remote devices 404. The first communication session may be based on one of the Server Message Block (SMB) protocol, the Common Internet File System (CIFS) protocol, or the Network File System (NFS) protocol The method 1600 includes establishing the second communication session for communicating one or more of metadata or the thumbnail image associated with the one or more files. The second communication session may be based on the Transmission Control Protocol (TCP).

At 1604, the method 1600 includes transmitting, by the host device 402, the request for the thumbnail image associated with each file among the one or more files from the one or more remote devices 404 in response to establishing the communication session.

The request for the thumbnail image may include the one or more of the configuration of the user interface, the file path, the height of the thumbnail image, the width of the thumbnail image, the orientation of the thumbnail image, and the output format of the thumbnail image.

At 1606, the method 1600 includes receiving, by the host device 402, the thumbnail image corresponding to each file among the one or more files from the one or more remote devices. The thumbnail image may be generated by the one or more remote devices based on the one or more files.

At 1608, the method 1600 includes displaying, by the host device 402, the thumbnail image corresponding to each file among the one or more files on the user interface of the host device to enhance remote file access.

The method 1600 includes transmitting, by the host device 402, the request for metadata associated with each file among the one or more files from the one or more remote devices 404. The method 1600 includes receiving, by the host device 402, the metadata corresponding to each file among the one or more files from the one or more remote devices 404. The method 1600 includes displaying, by the host device 402, the metadata corresponding to each file among the one or more files on the user interface of the host device 402 to enhance the remote file access.

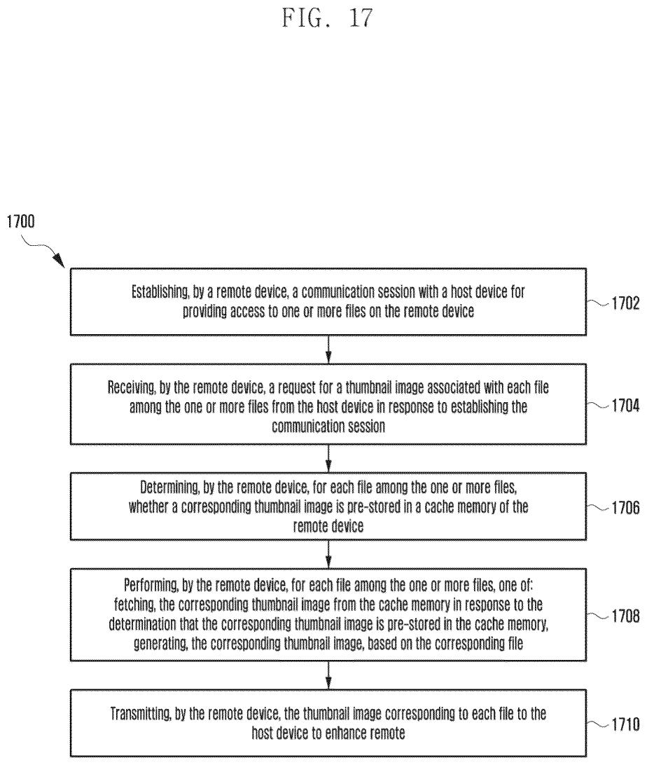

The method 1700 includes a series of operations shown at 1702 through 1710 of FIG. 17. The method 1700 may be performed by the system 405 in conjunction with modules 505, the details of which are explained in conjunction with FIGS. 5 to 15, and the same are not repeated here for the sake of brevity in the present disclosure. The method 1700 begins at 1702.

At 1702, the method 1700 includes establishing, by the remote device 404, the communication session with the host device 402 for providing access to the one or more files on the remote device 404.

Herein, the method 1700 includes establishing the first communication session for communicating the one or more files on the one or more remote devices 404. The first communication session may be based on one of the Server Message Block (SMB) protocol, the Common Internet File System (CIFS) protocol, or the Network File System (NFS) protocol Further, the method 1700 includes establishing the second communication session for communicating the one or more of metadata or the thumbnail image associated with the one or more files. The second communication session may be based on the Transmission Control Protocol (TCP).

At 1704, the method 1700 includes receiving, by the remote device 404, the request for the thumbnail image associated with each file among the one or more files from the host device 402 in response to establishing the communication session.

Herein, the request for the thumbnail image may include one or more of the configuration of the user interface, the file path, the height of the thumbnail image, the width of the thumbnail image, the orientation of the thumbnail image, and the output format of the thumbnail image.

At 1706, the method 1700 includes determining, by the remote device 404, for each file among the one or more files, whether the corresponding thumbnail image is pre-stored in the cache memory of the remote device 404.

At 1708, the method 1700 includes performing, by the remote device 404, for each file among the one or more files, one of fetching, the corresponding thumbnail image from the cache memory in response to the determination that the corresponding thumbnail image is pre-stored in the cache memory, or generating, the corresponding thumbnail image, based on the corresponding file.

Further, for generating the corresponding thumbnail image, the method 1700 may include extracting the bitmap image of the corresponding file based on the one or more parameters in the request for the thumbnail image. The one or more parameters may include one or more of the configuration of the user interface, the file path, the height of the thumbnail image, the width of the thumbnail image, the orientation of the thumbnail image, and the output format of the thumbnail image. The method 1700 may include resizing the bitmap image based on the one or more parameters. The method 1700 may include generating the corresponding thumbnail image by compressing the resized image.

In response to generating the corresponding thumbnail image, the method 1700 may include updating the corresponding thumbnail image in the cache memory.

At 1710, the method 1700 includes transmitting, by the remote device 404, the thumbnail image corresponding to each file to the host device 402 to enhance remote file access.

The method 1700 includes receiving, by the remote device 404, the request for metadata associated with each file among the one or more files from the host device 402 in response to establishing the communication session. The method 1700 includes transmitting, by the remote device 404, the metadata corresponding to each file to the host device 402. The metadata is obtained based on parsing a file header of the corresponding file.

At least by virtue of the aforesaid, embodiments of the present subject matter may provide the following advantages.

One or more embodiments of the present disclosure provide a dual communication session approach that separates file transfer operations from metadata and thumbnail image transfer operations, which may thereby reduce network overhead and improve overall performance for remote file access.

One or more embodiments of the present disclosure enable thumbnail image generation on the remote device based, which may thereby eliminate the need to download entire files or portions of files to the host device for thumbnail generation.

One or more embodiments of the present disclosure achieve a reduction in round trip time for fetching the thumbnail image, which may thereby provide a performance improvement compared to related art techniques.

One or more embodiments of the present disclosure reduce network bandwidth consumption by transmitting the thumbnail image and the metadata over the second communication session instead of transferring complete file data, which may thereby enable efficient remote file access even over limited network connections.

One or more embodiments of the present disclosure maintain compatibility with existing file sharing protocols including the SMB protocol, the CIFS protocol, and the NFS protocol for the first communication session, which may thereby enable integration with related art file sharing infrastructure.

One or more embodiments of the present disclosure support multi-device environment operation where the host device may communicate with the one or more remote devices simultaneously, which may thereby enable scalable remote file access across multiple devices.

While specific language has been used to describe the present disclosure, any limitations arising on account thereto, are not intended. As would be apparent to a person in the art, various working modifications may be made in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

What is claimed is:

1. A method for remote file access, the method comprising:
establishing, by a host device, a communication session with a remote device;
based on the communication session being established, transmitting, by the host device, a request for a thumbnail image associated with a file of the remote device;
receiving, by the host device, the thumbnail image corresponding to the file of the remote device, wherein the thumbnail image is generated by the remote device based on the file; and
displaying, by the host device, the thumbnail image associated with the file of the file on a user interface of the host device.

2. The method of claim 1, further comprising receiving, by the host device, the file from the remote device,
wherein the thumbnail image is received before the file is received or while the file is being received.

3. The method of claim 1, wherein the request for the thumbnail image includes one or more parameters indicating one or more conditions that the generated thumbnail image is required to satisfy,
the one or more parameters comprising at least one of a user-interface configuration, a file path, a height or width of the thumbnail image, an orientation of the thumbnail image, or an output format of the thumbnail image.

4. The method of claim 1, wherein the establishing the communication session comprises:
establishing a first communication session for accessing the file on the remote device, and
establishing a second communication session for transferring at least one of metadata associated with the file or the thumbnail image associated with the file.

5. The method of claim 4, wherein the first communication session is based on one of a Server Message Block (SMB) protocol, a Common Internet File System (CIFS) protocol, or a Network File System (NFS) protocol, and
wherein the second communication session is based on Transmission Control Protocol (TCP).

6. The method of claim 1, further comprising:
transmitting, by the host device, a request for metadata associated with each file of the file from the remote device;
receiving, by the host device, the metadata corresponding to each file of the file from the remote device; and
displaying, by the host device, the metadata corresponding to each file of the file on the user interface of the host device.

7. A method for remote file access, the method comprising:
establishing, by a remote device, a communication session with a host device for providing access to file on the remote device;
receiving, by the remote device, a request for a thumbnail image associated with each file of the file from the host device;
determining, by the remote device, for each file of the file, whether a corresponding thumbnail image is pre-stored in a cache memory of the remote device;
performing, by the remote device, for each file of the file, one of:
based on determining that the corresponding thumbnail image is pre-stored in the cache memory, fetching, the corresponding thumbnail image from the cache memory, or
generating, the corresponding thumbnail image, based on the corresponding file; and
transmitting, by the remote device, the thumbnail image corresponding to each file to the host device.

8. The method of claim 1, further comprising transmitting, by the remote device, the file to the host device,
wherein the thumbnail image is transmitted before the file is transmitted or while the file is being transmitted.

9. The method of claim 7, wherein the establishing the communication session comprises:
establishing a first communication session for accessing the file on the remote device, and
establishing a second communication session for transferring at least one metadata associated with the file or the thumbnail image associated with the file.

10. The method of claim 9, wherein the first communication session is based on one of a Server Message Block (SMB) protocol, a Common Internet File System (CIFS) protocol, or a Network File System (NFS) protocol, and
wherein the second communication session is based on Transmission Control Protocol (TCP).

11. The method of claim 7, further comprising:
based on the communication session being established, receiving, by the remote device, a request for metadata associated with each file of the file from the host device;
transmitting, by the remote device, the metadata corresponding to the file to the host device.

12. The method of claim 7, wherein the generating the corresponding thumbnail image comprises:
extracting a bitmap image of the corresponding file based on one or more parameters, indicating one or more conditions that the generated thumbnail image is required to satisfy, in the request for the thumbnail image, wherein the one or more parameters comprise at least one of a configuration of a user interface, a file path, a height of the thumbnail image, a width of the thumbnail image, an orientation of the thumbnail image, and an output format of the thumbnail image;
resizing the bitmap image based on the one or more parameters; and
generating the corresponding thumbnail image by compressing the resized bitmap image.

13. The method of claim 12, wherein one or more parameters comprises at least one of a configuration of the a user interface, a file path, a height of the thumbnail image, a width of the thumbnail image, an orientation of the thumbnail image, and an output format of the thumbnail image.

14. The method of claim 12, wherein the metadata is obtained based on parsing a file header of the corresponding file.

15. The method of claim 7, further comprising, based on the corresponding thumbnail image being generated, updating the corresponding thumbnail image in the cache memory.

16. An electronic device comprising:
a user interface;
memory storing instructions; and
at least one processor operatively coupled with the memory,
wherein the instructions, when executed by the at least one processor individually or collectively, cause the electronic device to:
establish a communication session with remote device for accessing a file on the remote device;
based on the communication session being established, transmit a request for a thumbnail image associated with the file from the remote device;
receive the thumbnail image corresponding to each file of the file from the remote device, wherein the thumbnail image is generated by the remote device based on the file; and
display the thumbnail image corresponding to each file of the file on the user interface.

17. The method of claim 16, further comprising receiving, by the host device, the file from the remote device,
wherein the thumbnail image is received before the file is received or while the file is being received.

18. The method of claim 16, wherein the request for the thumbnail image includes one or more parameters indicating one or more conditions that the generated thumbnail image is required to satisfy, the one or more parameters comprising at least one of a user-interface configuration, a file path, a height or width of the thumbnail image, an orientation of the thumbnail image, or an output format of the thumbnail image.

19. The electronic device of claim 16, wherein the instructions, when executed by the at least one processor individually or collectively, cause the electronic device to establish the communication session, the at least one processor by:
establishing a first communication session for accessing the file on the remote device, and
establishing a second communication session for transferring at least one of metadata associated with the file or the thumbnail image associated with the file.

20. An electronic device comprising:
memory storing instructions; and
a cache memory;
at least one processor operatively coupled with the memory and the cache memory,
wherein the instructions, when executed by the at least one processor individually or collectively, cause the electronic device to:
establish a communication session with a host device for providing access to a file on the electronic device;
receive a request for a thumbnail image associated with the file from the host device;
determine for the file, whether a corresponding thumbnail image is pre-stored in the cache memory;
perform for the file, one of:
based on determining that the corresponding thumbnail image is pre-stored in the cache memory, fetching, the corresponding thumbnail image from the cache memory, or
generating, the corresponding thumbnail image, based on the corresponding file; and
transmit the thumbnail image corresponding to each file to the host device.
